(19) United States
(12) Patent Application Publication
(10) Pub. No.: US 2008/0049103 A1
(43) Pub. Date: Feb. 28, 2008

(54) Information recording/reproducing apparatus

(75) Inventor: Yoshio Nakagawa, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/822,097

(22) Filed: Jul. 2, 2007

(30) Foreign Application Priority Data
Aug. 24, 2006 (JP) 2006-227312

(51) Int. Cl. H04N 7/18

(52) U.S. Cl. 348/143

(57) ABSTRACT

When the camera surveillance mode is set, the signal waveform data of the input video image from the camera is compared with the signal waveform data of the reference video image stored in advance in the memory. Then, it is determined whether or not there is a change in the signal of the input video image from the camera. When it is determined that there is a change in the signal of the input video image from the camera, then it is determined whether or not a number of scan lines in the signal of the input video image exceeds the set scan line change quantity that corresponds to a surveillance level selected by a user from among a plurality of surveillance levels. When it is determined that the number of scan lines in the signal of the input video image from the camera exceeds the set scan line change quantity, a warning is generated, thereby notifying an intruder.

This application is based on Japanese Patent Application No. 2006-227312 filed on Aug. 24, 2006, the contents of which are hereby incorporated by reference.

### BACKGROUND OF THE INVENTION

1. Field of the Invention

The present invention relates to an information recording/reproducing apparatus that records and reproduces information on and from a recording medium and is capable of recording a surveillance video image which is obtained by performing predetermined processing on a video image signal received from a camera.

2. Description of Related Art

Conventionally, in a security system for monitoring a large-scaled structure, inside a factory, a dam or a power transmission facility, a tunnel, or the like, it has been practiced to install a plurality of surveillance cameras over a wide area and a center surveillance apparatus connected to these surveillance cameras with dedicated lines, monitor the states of the sites by the center surveillance apparatus, and record the image of the state of the sites on a recording medium.

However, this type of security system requires a large-scaled arrangement, thus higher costs and is not suitable for an ordinary home. In light of this, there has been a demand for an imaging system that allows a commercially available camera to be connected to an image recording/reproducing apparatus such as a DVD recorder or a hard disk recorder and that allows a surveillance image taken by a camera installed at a watching place to be recorded by the image recording/reproducing apparatus.

JP-A-2002-288673 discloses a surveillance apparatus that digitally converts video image signals composed of a plurality of scan lines of an object image taken by a camera, compares waveform data of the converted video signals (corresponding to the waveform data of the input video image signals in the present invention) with a preset upper detection tolerance value or a preset lower detection tolerance value of reference waveform data of video image signals (corresponding to the signal waveform data of the reference video image in the present invention), detects whether or not there is a change in the object image, and thereby determines whether or not there is an intruder in a surveillance area.

JP-A-2002-312876 discloses a surveillance apparatus that compares reference image data of an image taken in the past by a door surveillance camera with current image data of an image recently taken. When a ratio of a number of pixels of the image data that are changed to the entire pixels of the reference image data exceeds a predetermined value, a notification is sent to a cellular telephone or this is notified by displaying on a display terminal to indicate that an abnormality has occurred.

However, in the surveillance apparatus disclosed in JP-A-2002-288673, it is determined whether or not an intruder is in an area monitored by a camera by comparing the waveform data of the video image signal with the preset upper detection tolerance value or a preset lower detection tolerance value of the reference waveform data of the video image signal and, thereby, detecting whether or not there is a change in an image of the object. For this reason, for example, when a garden is monitored at midnight, a parking area into which nobody is supposed to enter at midnight is monitored, or other areas are monitored, the apparatus may make a wrong determination by such a subtle change as swaying trees and movements of withered leaves caused by wind. This causes a problem in which, even if the watching area is intruded, the apparatus is incapable of notify a user correctly that there is an intruder.

JP-A-2002-312876 discloses a surveillance apparatus that compares the reference image data and the current image data, and, when a number of pixels of the image data that are changed over entire pixels of the reference image data exceeds a predetermined ratio, a notification is sent to a cellular telephone or this is notified by displaying on a display terminal to indicate that an abnormality has occurred. However, for example, when a garden is monitored at midnight, a parking area into which nobody is supposed to enter at midnight is monitored, or other areas are monitored, the apparatus may make a wrong determination by such a subtle change as swaying trees and movements of withered leaves caused by wind. This causes a problem in which, even if the watching area is intruded, the apparatus is incapable of notifying a user correctly that there is an intruder.

### SUMMARY OF THE INVENTION

The present invention is, by solving the aforementioned problem, to provide an information recording/reproducing apparatus capable of correctly notifying a user that there is an intruder when the watching area is intruded by providing surveillance levels among which one can be selected so as not to cause a wrong surveillance result.

To achieve the object, an information recording/reproducing apparatus of the present invention records and reproduces information on and from a recording medium and is so constructed as to be capable of receiving an input video image from a camera, performing a predetermined process on the input video image, and recording the input video image thus processed on the recording medium as a surveillance video image. The apparatus includes a video image change detector that determines whether or not there is a change in a signal of the input video image from the camera in comparison with a predetermined reference video image; determines whether or not a number of scan lines that are changed in the signal of the input video image exceeds a set scan line quantity corresponding to a surveillance level selected by a user from among a plurality of surveillance levels that are selectable when it is determined that there is a change in the signal of the input video image; and generates a warning signal when it is determined that said number of scan lines that are changed in the signal of the input video image exceeds said set scan line quantity.

According to one aspect of the present invention, plurality of surveillance levels can be provided. With this arrangement, for example, when a garden is monitored at midnight, a parking area into which nobody is supposed to enter at midnight is monitored, or other areas are monitored, it is possible to set such a surveillance level in which the apparatus does not make a wrong determination by such a subtle change as swaying trees and movements of withered leaves caused by wind. Therefore, it becomes possible to correctly notify a user that there is an intruder when the watching area is intruded.

### BRIEF DESCRIPTION OF THE DRAWINGS

FIG. 1 is a block diagram showing a structure of an image recording/reproducing apparatus of one embodiment of the present invention; and

FIG. 2 is a flowchart for explaining a process when the image recording/reproducing apparatus is set to a camera surveillance mode in the embodiment.

### DETAILED DESCRIPTION OF PREFERRED EMBODIMENTS

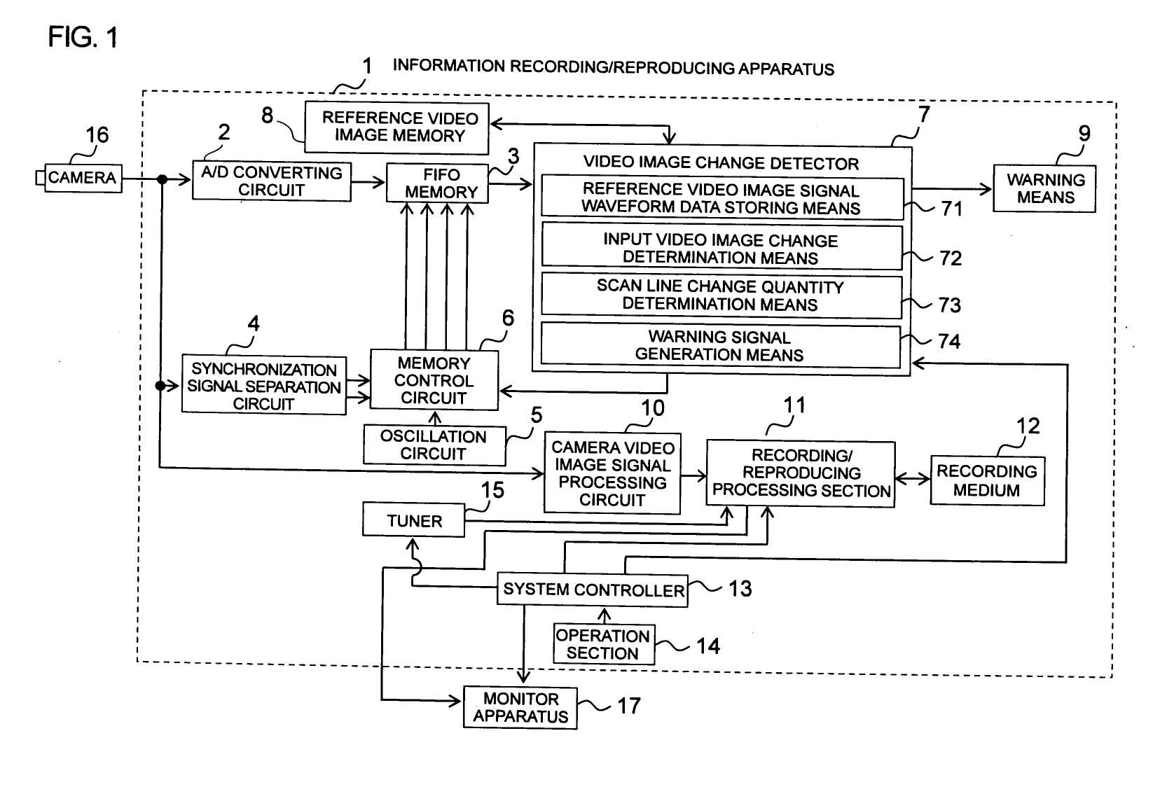

Hereinafter, the embodiment of the present invention will be described with reference to the accompanying drawings. FIG. 1 is a block diagram showing a structure of an information recording/reproducing apparatus of one embodiment of the invention. The image recording/reproducing apparatus may be a hard disk recorder, a DVD recorder, or a combination apparatus of hard disk and DVD recorders. Accordingly, a recording medium 12 described hereinafter is, for example, a hard disk or a DVD.

In FIG. 1, an information recording/reproducing apparatus 1 includes an A/D (analog/digital) converting circuit 2, a FIFO (first-in first-out) memory 3, a synchronization signal separation circuit 4, an oscillation circuit 5, a memory control circuit 6, a video image change detector 7, a reference video image memory 8, warning means 9, a camera video signal processing circuit 10, a recording/reproducing processing section 11, a recording medium 12, a system controller 13, an operation section 14, a tuner 15, and the like.

Particularly, the video image change detector 7 has: reference video image signal waveform data storing means 71 that stores in advance into the reference video image memory 8, as the signal waveform data of the reference video image, the waveform data of the digital video image found to have no changes in scan lines of a video image that is entered from a camera 16; input video image change determination means 72 that receives an video image signal from the camera 16 which is set to a camera surveillance mode through the operation on the operation section 14, compares the signal waveform data of the digitally converted input video image with the signal waveform data of the reference video image stored in the reference video image memory 8, and, thereby, determines whether or not there is a change in the signal of the input video image from the camera 16; scan line change quantity determination means 73 that determines whether or not a number of scan lines of the signal of the input video image exceeds a set scan line change quantity that corresponds to a surveillance level selected by a user from among a plurality of surveillance levels when it is determined that there is a change in the signal of the input video image from the camera 16; and warning signal generation means 74 that generates a warning signal when it is determined that a number of scan lines of the signal of the input video image that are changed exceeds the set scan line change quantity. It is to be noted that a partial area in the video image memory provided originally in the information recording/reproducing apparatus 1 may be used as the reference video image memory 8 although it is not shown. With this arrangement, no additional memory needs to be provided.

In the information recording/reproducing apparatus 1 structured in this way, the A/D converting circuit 2 converts the analog video image signal entered from the camera 16 into the digital video image signal. The FIFO memory 3 memorizes the digital video image signal from the A/D converting circuit 2 as the signal waveform data of the input video image. The synchronization signal separation circuit 4 separates a vertical synchronization signal and a horizontal synchronization signal included in the signal of the input video image from the camera 16 and outputs the vertical and horizontal synchronization signals respectively. The memory control circuit 6 receives the vertical and horizontal synchronization signals from the synchronization signal separation circuit 4 and, in synchronization therewith, outputs a write clock signal and a write address reset signal for a write control signal to the FIFO memory 3. The memory control circuit 6, upon receiving a readout control signal from the video image change detector 7, outputs the read-out clock signal and the read-out address reset signal. The oscillation circuit 5 outputs an A/D conversion clock signal and a memory control clock signal.

The video image change detector 7 feeds the read-out control signal to the memory control circuit 6 for reading out the signal waveform data of the input video image from the FIFO memory 3, compares the signal waveform data of the input video image that is read out from the FIFO memory 3 in which the signal waveform data has been stored with the signal waveform data of the reference video image stored in advance in the reference video image memory 8, and determines whether or not there is a change in the signal of the input video image from the camera 16. In other words, the video image change detector 7 receives the signal of the input video image from the camera 16 which is set to the camera surveillance mode through the operation on the operation section 14, compares the signal waveform data of the input video image that is converted into a digital format with the signal waveform data of the reference video image stored in the reference video image memory 8, and, thereby, determines by using the input video image change determination means 72 whether or not there is a change in the signal of the input video image from the camera 16.

In addition, when it is determined that there is a change in the signal of the input video image from the camera 16, the video image change detector 7 determines with the scan line change quantity determination means 73 whether or not a number of scan lines of the signal of the input video image that are changed exceeds the set scan line change quantity corresponding to the surveillance level that is selected from among the plurality of surveillance levels through the user's operation, generates by using the warning signal generation means 74 a warning signal when it is determined that the number of scan lines of the signal of the input video image exceeds the set scan line change quantity. The warning means 9 is a light-emitting diode that emits light in response to the warning signal from the video image change detector 7, a buzzer that generates a warning sound in response to the warning signal, or the like.

The camera video image signal processing circuit 10 performs processing to convert the signal of the input video image from the camera 16 into a video signal format which can be handled by the recording/reproducing processing section 11. The recording/reproducing processing section 11 compresses an audio visual signal of a TV broadcast that is obtained by tuning the station through a tuner 15 or an audio/video signal from another unillustrated reproducing apparatus into a predetermined format and stores the compressed data into the recording medium 12 as audio/video data, decompresses the audio/video data stored in the recording medium 12 into a predetermined format and reproduces as audio/video signal, or compresses the camera audio/video signal from the camera video image signal processing circuit 10 into a predetermined format and stores into the recording medium 12 as audio/video data. Among these signals, the reproduced audio/video signal is fed to a monitor apparatus 17, the video signal is reproduced by a display apparatus as a video image thereon, and the audio signal is reproduced by a loudspeaker or the like as a sound. The system controller 13 controls the video image change detector 7, the recording/reproducing processing section 11, the tuner 15, the monitor apparatus 17, and the like and performs various controls in response to an operation signal corresponding to key operations on the operation section 14 such as a remote controller.

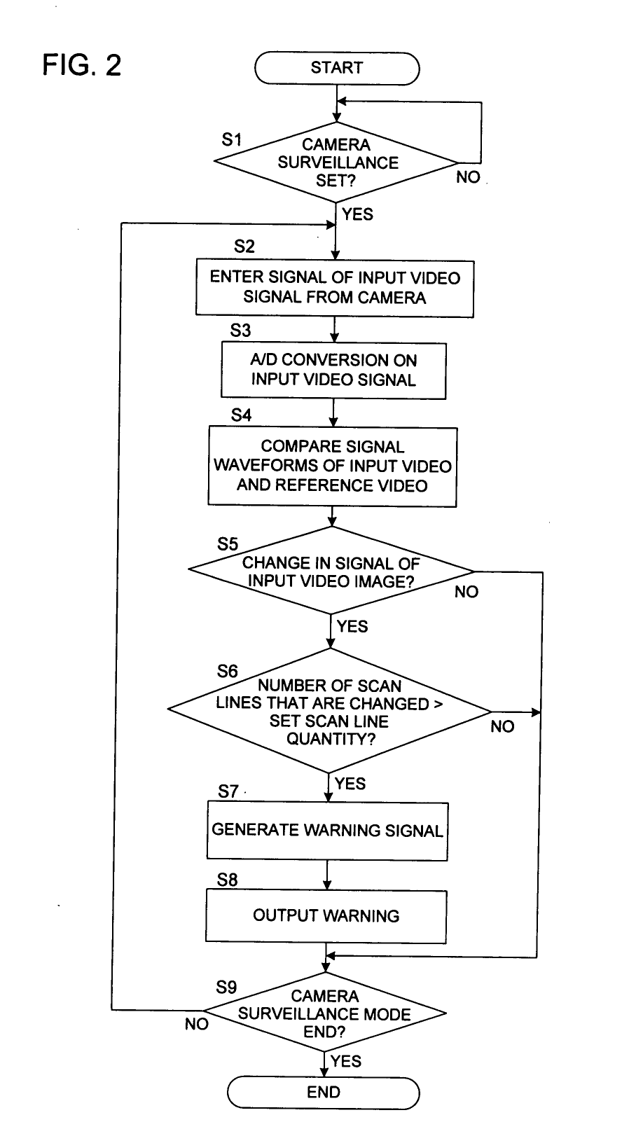

FIG. 2 is a flowchart for explaining a process when the image recording/reproducing apparatus in this embodiment is set to the camera surveillance mode. The process when the image recording/reproducing apparatus is set to the camera surveillance mode will be described with reference to this flowchart and FIG. 1.

Before the camera surveillance mode is set, it is necessary to receive the video image signal of a still image of a place to be monitored which is taken by the camera 16 and store the signal waveform data of the reference video image into the reference video image memory 8. To do this, the reference video image signal waveform data storing means 71 of the video image change detector 7, upon receiving the video image signal from the camera 16, stores the signal waveform data of the digitized video image while the scan lines of the video image signal unchanged into the reference video image memory 8 as the signal waveform data of the reference video image. In other words, the video image signal from the camera 16 is converted into a digital format by the A/D conversion circuit 2, the digital video image signal is stored into the FIFO memory 3 as the signal waveform data of the input video image. However, the data which has not changed among the signal waveform data of the input video image is stored into the reference video image memory 8 as the signal waveform data of the reference video image.

After the signal waveform data of the reference video image is stored into the reference video image memory 8 in this way and when the system controller 10 detects that the camera surveillance mode is set through the operation on the operation section 14 (Step S1), the system controller 10 sets the operation mode of the information recording/reproducing apparatus 1 to the camera surveillance mode. Through this process, the signal of the input video image is fed in from the camera 16 (Step S2), and the signal of the input video image is converted from analog into digital by the A/D conversion circuit 2 (Step S3). Then, the memory control circuit 6 controls the FIFO memory 3 so that the signal of the input video image that has been digitized through the A/D conversion is stored into the FIFO memory 3 as the signal waveform data of the input video image.

By controlling the memory control circuit 6, the input video image change determination means 72 of the video image change detector 7 controls the FIFO memory 3 to be read, reads out the signal waveform data of the input video image from the FIFO memory 3, reads out the signal waveform data of the reference video image from the reference video image memory 8, compares the signal waveform data of the input image and the signal waveform data of the reference video image (Step S4), and determines whether or not there is a change in the signal of the input video image from the camera 16 by using a known technology (Step S5).

When it is determined that there is no change in the signal of the input video image from the camera 16, no warning is made. However, when it is determined that there is a change in the signal of the input video image from the camera 16, the scan line change quantity determination means 73 of the video image change detector 7 determines whether or not a number of scan lines of the signal of the input video image exceeds a set scan line change quantity that corresponds to a surveillance level selected by a user from among a plurality of surveillance levels (Step S6). Here, the detection of the number of scan lines that are changed is made possible by checking a quantity of lines that are changed during a scanning period (a period between blanking signals) of the video image signal.

For example, if five surveillance levels are provided, the number of changed scan lines is arranged in five levels, namely, 100, 200, 300, 400, and 500 in the progressive scan method because there are 525 scan lines in total in NTSC system. In this example, the user operates through the operation section 14 so as to display the camera surveillance mode setting screen on the monitor apparatus 17 and arrange the surveillance levels 1, 2, 3, 4, and 5 in the order in which the surveillance sensitivity increases as the level number increases larger and arrange the number of changed scan lines, 100, 200, 300, 400, and 500 for the surveillance levels respectively. In step 6, in the description thereof, it is assumed that the surveillance level is set to “2” and, thus the set scan line change quantity is set to “200”.

However, if the scan method is the interlaced scan method, one frame is comprised of two fields (one screen). The number of scan lines in one field is a half of that of the progressive scan method. Therefore, the number of changed scan lines corresponding to the surveillance levels 1, 2, 3, 4, and 5 will be 50, 100, 150, 200, and 250, respectively.

Now, in step S6, when the number of scan lines that are changed in the signal of the input video image from the camera 16 exceeds the set scan line change quantity (200 lines), the warning signal generation means 74 of the image change detector 7 generates a warning signal (Step S7), and, thereby, the warning means 9 outputs a warning (Step S8). If the warning means 9 is an light-emitting diode, then it lights up or blinks. If the warning means 9 is a buzzer, then it generates a notification sound. Without limiting the warning means 9 to the light-emitting diode or the buzzer, the warning means 9 may be any one of the light output means and sound output means that is capable of notifying the user.

According to this embodiment as described above, since a plurality of surveillance levels is arranged, for example, when a garden is monitored at midnight, a parking area into which nobody is supposed to enter at midnight is monitored, or other areas are monitored, it is possible to set such a surveillance level (surveillance sensitivity) that the apparatus does not make a wrong determination by such a subtle change as swaying trees and movements of withered leaves caused by wind. With this arrangement, it becomes possible to correctly notify a user that there is an intruder when the watching area is intruded.

What is claimed is:

1. An information recording/reproducing apparatus that records and reproduces information on and from a recording medium and is so constructed as to be capable of receiving an input video image from a camera, performing a predetermined process on the input video image, and recording the input video image thus processed on the recording medium as a surveillance video image, comprising,
a video image change detector that
determines whether or not there is a change in a signal of the input video image from the camera in comparison with a predetermined reference video image,
determines whether or not a number of scan lines that are changed in the signal of the input video image exceeds a set scan line quantity corresponding to a surveillance level selected by a user from among a plurality of surveillance levels that are selectable when it is determined that there is a change in the signal of the input video image, and
generates a warning signal when it is determined that said number of scan lines that are changed in the signal of the input video image exceeds said set scan line quantity.

2. The information recording/reproducing apparatus according to claim 1,
wherein the video image change detector comprises:
input video image change determination means that determines whether or not there is a change in the signal of the input video image by comparing signal waveform data of the input video image arranged by receiving and digitally converting the signal of the input video image with signal waveform data of the reference video image;
scan line change quantity determination means that determines whether or not said number of scan lines that are changed in the signal of the input video image exceeds said set scan line quantity corresponding to the surveillance level selected by the user from among the plurality of surveillance levels that are selectable when it is determined that there is a change in the signal of the input video image; and
warning signal generation means that generates the warning signal when it is determined that said number of scan lines that are changed in the signal of the input video image exceeds said set scan line quantity.

3. The information recording/reproducing apparatus according to claim 2,
wherein the video image change detector further comprises
reference video image signal waveform data storing means that stores the signal waveform data of the input video image that is received from the camera and digitally converted when there are no changes in scan lines of the signal of the input video image into a memory as the signal waveform data of the reference video image.

4. An information recording/reproducing apparatus that records and reproduces information on and from a recording medium and is so constructed as to be capable of receiving an input video image from a camera, performing a predetermined process on the input video image, and recording the input video image thus processed on the recording medium as a surveillance video image, comprising,
a video image change detector including:
reference video image signal waveform data storing means that stores signal waveform data of the input video image that is received from the camera and digitally converted when there are no changes in scan lines of a signal of the input video image into a memory as signal waveform data of a reference video image;
input video image change determination means that determines whether or not there is a change in the signal of the input video image by comparing the signal waveform data of the input video image arranged by receiving and digitally converting the signal of the input video image with the signal waveform data of the reference video image stored in the memory;
scan line change quantity determination means that determines whether or not a number of scan lines that are changed in the signal of the input video image exceeds a set scan line quantity corresponding to a surveillance level selected by a user from among a plurality of surveillance levels that are selectable when it is determined that there is a change in the signal of the input video image; and
warning signal generation means that generates a warning signal when it is determined that said number of scan lines that are changed in the signal of the input video image exceeds said set scan line quantity.

5. The information recording/reproducing apparatus according to claim 4, further comprising:
an A/D converting circuit that converts the input video image from the camera into signal waveform data of a digital video image;
a FIFO memory that stores temporarily and outputs the signal waveform data of the digital video image to the video image change detector;
a synchronization signal separation circuit that separates a vertical synchronization signal and a horizontal synchronization signal included in the signal of the input video image from the camera 16 and outputs the vertical and horizontal synchronization signals respectively;
a memory control circuit that, by receiving the vertical and horizontal synchronization signals that are separated, outputs in synchronization therewith a write clock signal for writing the signal waveform data of the digital video image to the FIFO memory, and, by receiving a readout control signal from the video image change detector, outputs to the FIFO memory a readout clock signal for the video image change detector to read out the signal waveform data memorized in the FIFO memory.
